(19) United States
(12) Patent Application Publication
(10) Pub. No.: US 2024/0127827 A1
(43) Pub. Date: Apr. 18, 2024

(54) MATCHING AUDIO USING MACHINE LEARNING BASED AUDIO REPRESENTATIONS

(71) Applicant: QUALCOMM Incorporated, San Diego, CA (US)

(72) Inventors: Stephane VILLETTE, San Diego, CA (US); Sen LI, San Diego, CA (US); Pravin Kumar RAMADAS, San Diego, CA (US); Daniel Jared SINDER, San Diego, CA (US)

(21) Appl. No.: 18/047,565

(22) Filed: Oct. 18, 2022

(51) Int. Cl. G10L 19/00; H04L 65/70

(52) U.S. Cl. CPC G10L 19/00; H04L 65/70

(57) ABSTRACT

Systems and techniques are described herein for encoding and/or decoding audio information. For example, a process can process an input audio segment to generate a representation of the input audio segment, and can compare the representation of the input audio segment to representations stored in a memory. The representations represent a plurality of audio segments. The process can determine, based on the comparison, target representation(s) of target audio segment(s) from the representations stored in the memory. The process can determine one or more indices associated with the target audio segment(s). The process can then packetize the one or more indices and transmit the one or more packetized indices (e.g., to a decoder configured to decode the packetized indices).

### FIELD

This application is related to processing audio data. For example, systems and techniques are described for matching input audio to stored audio using machine learning based audio representations (e.g., embedding vectors) and performing one or more functions based on a result of the matching.

### BACKGROUND

Electronic devices, such as smartphones, tablet computers, wearable electronic devices, smart TVs, and the like are becoming increasingly popular among consumers. These devices can provide audio (e.g., voice or speech, music, etc.) and/or data communication functionalities over wireless or wired networks. In addition, such electronic devices can include other features that provide a variety of functions designed to enhance user convenience. Digital audio includes a large amount of data to meet the demands of consumers and audio providers.

Speech is one example of audio. Speech applications may rely on being able to model speech effectively using speech models. Speech models can be used by application such as speech coding, voice conversion, keyword spotting, speech quality evaluation, etc. The speech quality, low bit rate, and detection ability of these systems depend on the quality of the underlying model.

### SUMMARY

Systems and techniques are described herein for processing audio data. In some aspects, the systems and techniques described herein relate to an apparatus for encoding audio information, the apparatus including: at least one memory; and at least one processor coupled to the at least one memory and configured to: detect an input audio segment; process the input audio segment to generate a representation of the input audio segment; compare the representation of the input audio segment to a plurality of representations stored in the at least one memory, the plurality of representations representing a plurality of audio segments; determine, based on comparing the representation to the plurality of representations, one or more target representations of one or more target audio segments from the plurality of representations stored in the at least one memory; determine one or more indices associated with the one or more target audio segments; packetize the one or more indices; and transmit the one or more packetized indices.

In some aspects, the systems and techniques described herein relate to a method for encoding audio information, including: detecting an input audio segment; processing the input audio segment to generate a representation of the input audio segment; comparing the representation of the input audio segment to a plurality of representations stored in at least one memory, the plurality of representations representing a plurality of audio segments; determining, based on comparing the representation to the plurality of representations, one or more target representations of one or more target audio segments from the plurality of representations stored in the at least one memory; determining one or more indices associated with the one or more target audio segments; packetizing the one or more indices; and transmitting the one or more packetized indices.

In some aspects, the systems and techniques described herein relate to a non-transitory computer-readable medium that has stored thereon instructions that, when executed by one or more processors, cause the at one or more processors to: detect an input audio segment; process the input audio segment to generate a representation of the input audio segment; compare the representation of the input audio segment to a plurality of representations stored in at least one memory, the plurality of representations representing a plurality of audio segments; determine, based on comparing the representation to the plurality of representations, one or more target representations of one or more target audio segments from the plurality of representations stored in the at least one memory; determine one or more indices associated with the one or more target audio segments; packetize the one or more indices; and transmit the one or more packetized indices.

In some aspects, the systems and techniques described herein relate to an apparatus for encoding audio information. The apparatus includes: means for detecting an input audio segment; means for processing the input audio segment to generate a representation of the input audio segment; means for comparing the representation of the input audio segment to a plurality of representations stored in at least one memory, the plurality of representations representing a plurality of audio segments; means for determining, based on comparing the representation to the plurality of representations, one or more target representations of one or more target audio segments from the plurality of representations stored in the at least one memory; means for determining one or more indices associated with the one or more target audio segments; means for packetizing the one or more indices; and means for transmitting the one or more packetized indices.

In some aspects, the systems and techniques described herein relate to an apparatus for decoding audio information, the apparatus including: at least one memory; and at least one processor coupled to the at least one memory and configured to: receive one or more packetized indices associated with one or more target audio segments; depacketize the one or more packetized indices to generate one or more indices associated with the one or more target audio segments; retrieve, from the at least one memory, the one or more target audio segments based on the one or more indices; and combine the one or more target audio segments to generate decoded audio.

In some aspects, the systems and techniques described herein relate to a method of decoding audio information, including: receiving one or more packetized indices associated with one or more target audio segments; depacketizing the one or more packetized indices to generate one or more indices associated with the one or more target audio segments; retrieving, from at least one memory, the one or more target audio segments based on the one or more indices; and combining the one or more target audio segments to generate decoded audio.

In some aspects, the systems and techniques described herein relate to a non-transitory computer-readable medium that has stored thereon instructions that, when executed by one or more processors, cause the at one or more processors to: receive one or more packetized indices associated with one or more target audio segments; depacketize the one or more packetized indices to generate one or more indices associated with the one or more target audio segments; retrieve, from at least one memory, the one or more target audio segments based on the one or more indices; and combine the one or more target audio segments to generate decoded audio.

In some aspects, the systems and techniques described herein relate to an apparatus for decoding audio information. The apparatus includes: means for receiving one or more packetized indices associated with one or more target audio segments; means for depacketizing the one or more packetized indices to generate one or more indices associated with the one or more target audio segments; means for retrieving, from at least one memory, the one or more target audio segments based on the one or more indices; and means for combining the one or more target audio segments to generate decoded audio.

In some aspects, one or more of the apparatuses described herein is, is part of, and/or includes a mobile device or a wireless communication device (e.g., a mobile telephone or other mobile device), an extended reality (XR) device or system (e.g., a virtual reality (VR) device, an augmented reality (AR) device, or a mixed reality (MR) device), a vehicle or a computing device or component of a vehicle, a wearable device (e.g., a network-connected watch or other wearable device), a camera, a personal computer, a laptop computer, a server computer or server device (e.g., an edge or cloud-based server, a personal computer acting as a server device, a mobile device such as a mobile phone acting as a server device, an XR device acting as a server device, a vehicle acting as a server device, a network router, or other device acting as a server device), another device, or a combination thereof. In some aspects, the apparatus(es) includes a camera or multiple cameras for capturing one or more images. In some aspects, the apparatus(es) further includes a display for displaying one or more images, notifications, and/or other displayable data. In some aspects, the apparatus(es) can include one or more sensors (e.g., one or more inertial measurement units (IMUs), such as one or more gyroscopes, one or more gyrometers, one or more accelerometers, any combination thereof, and/or other sensor. In some aspects, the apparatus(es) can include a receiver configured to receive information or data, transmitter configured to transmit information or data, and/or a transceiver configured to receive and transmit information or data.

The above-described aspects relating to any of the methods, apparatuses, and computer-readable media can be used individually or in any suitable combination.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and embodiments, will become more apparent upon referring to the following specification, claims, and accompanying drawings.

### BRIEF DESCRIPTION OF THE DRAWINGS

Examples of various implementations are described in detail below with reference to the following figures:

FIG. 1 is a block diagram illustrating an example system-on-a-chip (SoC) that can include an audio processing system, in accordance with some examples;

FIG. 2 is a diagram illustrating an example of an audio processing system, in accordance with aspects of the present disclosure;

FIG. 3 is a block diagram illustrating an example operation of an audio representation search and comparison engine of the audio processing engine of FIG. 2, in accordance with aspects of the present disclosure;

FIG. 4A is a diagram illustrating an example of a speech encoder and a speech decoder, in accordance with aspects of the present disclosure;

FIG. 4B is a diagram illustrating an example of encoding of indices, in accordance with aspects of the present disclosure;

FIG. 5 is a diagram illustrating an example of audio framing using fixed-length segments, in accordance with aspects of the present disclosure;

FIG. 6 is a diagram illustrating an example of audio framing using variable-length segments, in accordance with aspects of the present disclosure;

FIG. 7A-7C are diagrams illustrating examples of neural networks, in accordance with some examples;

FIG. 8 is a block diagram illustrating an example of a deep convolutional network (DCN), in accordance with aspects of the present disclosure;

FIG. 9 is a flow diagram illustrating an example of a process for encoding audio information, in accordance with aspects of the present disclosure;

FIG. 10 is a flow diagram illustrating an example of a process for decoding audio information, in accordance with aspects of the present disclosure;

FIG. 11 is an example computing device architecture of an example computing device that can implement the various techniques described herein.

### DETAILED DESCRIPTION

Certain aspects and embodiments of this disclosure are provided below. Some of these aspects and embodiments may be applied independently and some of them may be applied in combination as would be apparent to those of skill in the art. In the following description, for the purposes of explanation, specific details are set forth in order to provide a thorough understanding of embodiments of the application. However, it will be apparent that various embodiments may be practiced without these specific details. The figures and description are not intended to be restrictive.

The ensuing description provides example embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the application as set forth in the appended claims.

Systems and devices can benefit from an ability to compare received audio information (e.g., speech or voice information, music, recorded sounds, etc.) with stored audio information in order determine a similarity between the received audio information and stored audio information. For example, a system can use such a comparison to perform keyword detection, voice recognition, speech quality assessment, among other tasks. However, audio information can include large amounts of data, in which case storing the data can lead to large storage costs. More efficient systems and techniques are needed for matching input audio to stored audio.

Systems, apparatuses, electronic devices, methods (also referred to as processes), and computer-readable media (collectively referred to herein as “systems and techniques”) are described herein for matching input audio to stored audio using machine learning based audio representations (e.g., embedding vectors) and performing one or more functions based on a result of the matching. For example, a machine learning system can process stored audio (e.g., Pulse-code modulation (PCM) speech samples) to generate representations (e.g., feature vectors or embedding vectors) of the stored audio that represent characteristics of the audio data. The representations of the stored speech can be stored in an audio representation storage (e.g., an audio representation database). Such representations can be referred to as deep audio representations (e.g., deep speech representations). The same machine learning system can process input audio to generate representations (e.g., feature vectors or embedding vectors) of the input audio that represent characteristics of the input audio data. The systems and techniques can then compare the representations generated for the input audio to the representations generated for the stored audio to determine one or more closest matching representation in the audio representation storage.

The audio can include speech or voice, music, recorded sounds, any combination thereof, and/or other types of audio. Examples will be described herein using speech for illustrative purposes. However, one of ordinary skill will appreciate that the systems and techniques described herein apply to any type of audio information.

The systems and techniques can perform one or more functions based on the matching representation(s) from the audio representation storage. In one illustrative example, the systems and techniques can be used to implement a speech encoder, a speech decoder, or a combined speech encoder-decoder (codec). In such an example, representations stored in the audio representation storage can represent speech from multiple people (or “talkers”). For instance, a speech encoder can include an audio storage that stores the speech from the multiple people. A speech decoder can also include an audio storage that stores the speech from the multiple people. The machine learning model on the encoder can process speech stored at the encoder to generate representations (e.g., feature or embedding vectors) of the stored speech. For instance, the stored speech can be divided into segments. The segments can be fixed-length segments or can be variable-length segments. In the event the audio is divided into variable-length segments, the encoder can resample the segments to convert the segments having the variable length into audio segments having a fixed length (e.g., so that the speech segments have the same length or duration). The machine learning model can generate one or more respective representations for each segment (e.g., 12 feature vectors having 512 values for each segment having a duration or length of 120 milliseconds).

The encoder can receive a speech input of a person talking. The machine learning model (the same model used to generate the representations stored in the audio representation storage) can generate one or more representations (e.g., one or more feature or embedding vectors) for the speech input. For instance, similar to the stored speech, the encoder can divide the input speech into segments (e.g., fixed-length or variable-length segments) and can generate one or more respective representations for each segment. The encoder can then determine representation(s) of the stored speech in the audio representation storage that match the representation(s) of the speech input. For instance, a distance metric (e.g., mean-squared error (MSE), Root Mean Squared Error (RMSE), Sum of squared errors (SSE), or other distance metric) can be used to compare the representation(s) of the stored speech to the representation(s) of the speech input. The encoder can determine an index identifying a location in the audio storage for a speech segment that corresponds to a stored representation determined to match a segment of the speech input.

Once the indices for the matching speech are determined, the encoder can encode the indices into a bitstream (e.g., by quantizing and/or entropy coding the index values). The encoder can then store the bitstream and/or transmit the bitstream to the speech decoder. The speech decoder can decode the bitstream (e.g., by performing inverse quantization and/or entropy decoding) to determine the indices represented in the bitstream. The decoder can then use each respective index to identify a location in the audio storage of the matching speech segments that correspond to the input speech. The decoder can retrieve the speech segments from the audio storage, and can combine (e.g., concatenate or otherwise combine) the speech segments to generate reconstructed or decoded speech that is similar to (e.g., sounds similar to) the input speech.

In another illustrative example, the systems and techniques can be used for voice activation. In such an example, representations stored in the audio representation storage can represent keywords that, if recognized in input speech, can be used to activate a device comprising a voice activation system to perform one or more functions (e.g., launch one or more applications, play music, set a timer, etc.). The voice activation system can receive speech input, generate one or more representations (e.g., a feature or embedding vector) of the speech input using the machine learning system, and determine if the representation of the speech input matches one of the representations of the keywords stored in the audio representation storage. If a match is determined, the voice activation system can activate the corresponding function of the device.

Other examples of applications for which the systems and techniques can be used include speech quality assessment (e.g., by measuring how well representations of speech input match stored representations of stored speech), voice conversion (e.g., by outputting stored speech corresponding to a stored speech representation determined to match a speech representation generated for a speech input), audio event detection (e.g., by identifying and outputting an indication of stored speech corresponding to a stored speech representation determined to match a speech representation generated for a speech input), among others. Various aspects of the present disclosure will be described with respect to the figures.

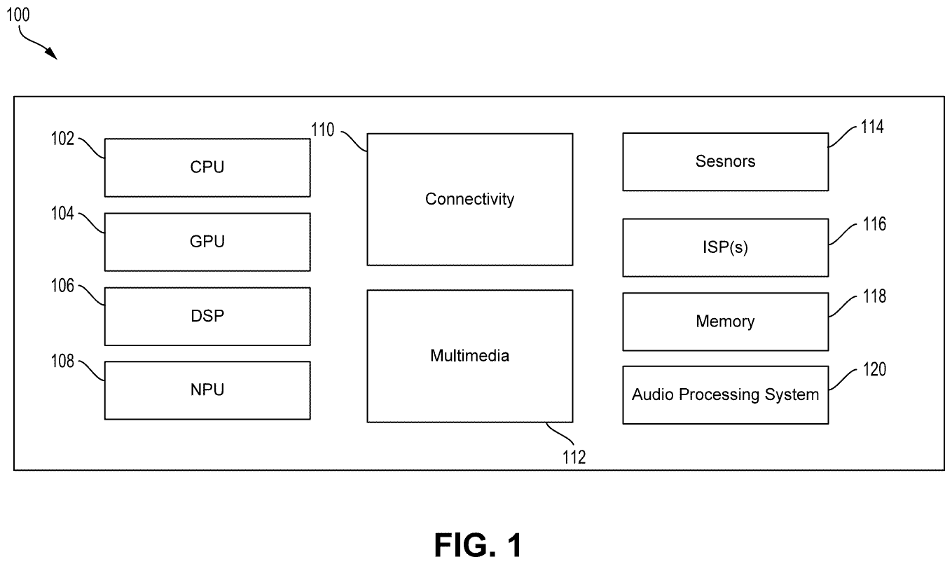

FIG. 1 illustrates an example implementation of a system-on-a-chip (SoC) 100, which may include a central processing unit (CPU) 102 or a multi-core CPU, configured to perform one or more of the functions described herein. Parameters or variables (e.g., neural signals and synaptic weights), system parameters associated with a computational device or model (e.g., a neural network model with parameters such as weights, biases, and/or other parameters), delays, frequency bin information, task information, among other information may be stored in a memory block associated with a neural processing unit (NPU) 108, in a memory block associated with a CPU 102, in a memory block associated with a graphics processing unit (GPU) 104, in a memory block associated with a digital signal processor (DSP) 106, in a memory block 118, and/or may be distributed across multiple blocks. Instructions executed at the CPU 102 may be loaded from a program memory associated with the CPU 102 or may be loaded from a memory block 118.

The SoC 100 may also include additional processing blocks tailored to specific functions, such as the GPU 104, the DSP 106, a connectivity block 110, which may include fifth generation (5G) connectivity, fourth generation long term evolution (4G LTE) connectivity, Wi-Fi connectivity, USB connectivity, Bluetooth connectivity, and the like, and a multimedia processor 112 that may, for example, detect and recognize gestures, speech, and/or other interactive user action(s) or input(s). In one implementation, the NPU 108 is implemented in the CPU 102, DSP 106, and/or GPU 104. The SoC 100 may also include a sensor processor 114, one or more image signal processors (ISPs) 116, and/or an audio processing system 120. In some examples, the sensor processor 114 can be associated with or connected to one or more sensors for providing sensor input(s) to sensor processor 114. For example, the one or more sensors and the sensor processor 114 can be provided in, coupled to, or otherwise associated with a same computing device.

In some examples, the one or more sensors can include one or more microphones for receiving an audio input. The audio input can include ambient sounds in the vicinity of a computing device associated with the SoC 100 and/or may include speech from a user of the computing device associated with the SoC 100 or one or more other users. In some cases, a computing device associated with the SoC 100 can additionally, or alternatively, be communicatively coupled to one or more peripheral devices (not shown) and/or configured to communicate with one or more remote computing devices or external resources, for example using a wireless transceiver and a communication network, such as a cellular communication network.

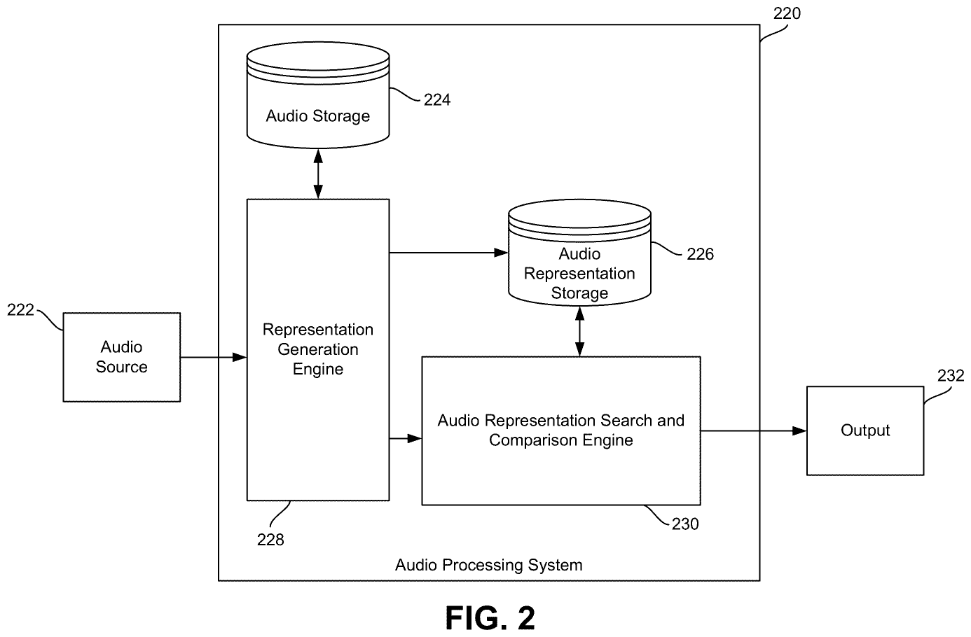

In some cases, the audio input received by the one or more microphones (and/or other sensors) may be processed by the SoC 100, CPU 102, DSP 106, NPU 108, and/or audio processing system 120. For example, the audio processing system 120 can utilize a machine learning model (e.g., implemented using the CPU 102, DSP 106, and/or NPU 108) to process stored audio to generate representations of the stored audio that represent characteristics of the audio data. The representations of the stored speech can be stored in an audio representation storage (e.g., an audio representation database) that can be part of the audio processing system 120, part of the SoC 100, and/or external to the SoC 100 (e.g., on a separate chip, device, or system, such as a cloud server). The audio processing system 120 can utilize the same machine learning model to process the input audio received by the one or more microphones (and/or other sensors) to generate representations of the input audio that represent characteristics of the input audio data. The audio processing system 120 can compare the representations generated for the input audio to the representations generated for the stored audio to determine one or more closest matching representation in the audio representation storage. The audio processing system 120, the SoC 100, an application in communication with the SoC 100, and/or other system, device, or component can perform one or more functions based on the matching representation(s) from the audio representation storage. Aspects regarding the audio processing system 120 will be discussed in more detail below with respect to FIG. 2 and/or other figures.

FIG. 2 is a diagram illustrating an example of an audio processing system 220, in accordance with aspects of the present disclosure. The audio processing system 220 is an illustrative example of the audio processing system 120 of FIG. 1. As shown in FIG. 2, the audio processing system 220 includes an audio storage 224, an audio representation storage 226, a representation generation engine 228, and an audio representation search and comparison engine 230.

The audio storage 224 can store audio data and the audio representation storage 226 can store representations of the audio data stored in the audio storage 224. As described below, the representations are generated by the representation generation engine 228. In some aspect, the audio storage 224 can be a first database (e.g., an audio representation database) and the audio representation storage 226 can be a second database (e.g., an audio representation database) that is separate from the first database. In other examples, the audio storage 224 and the audio representation storage 226 can be part of the same database, such as where the content of the audio storage 224 is stored separately from the content of the audio representation storage 226. While the audio storage 224 and the audio representation storage 226 are shown to be part of the audio processing system 220, in some cases the audio storage 224 and/or the audio representation storage 226 can be separate from the audio processing system 220.

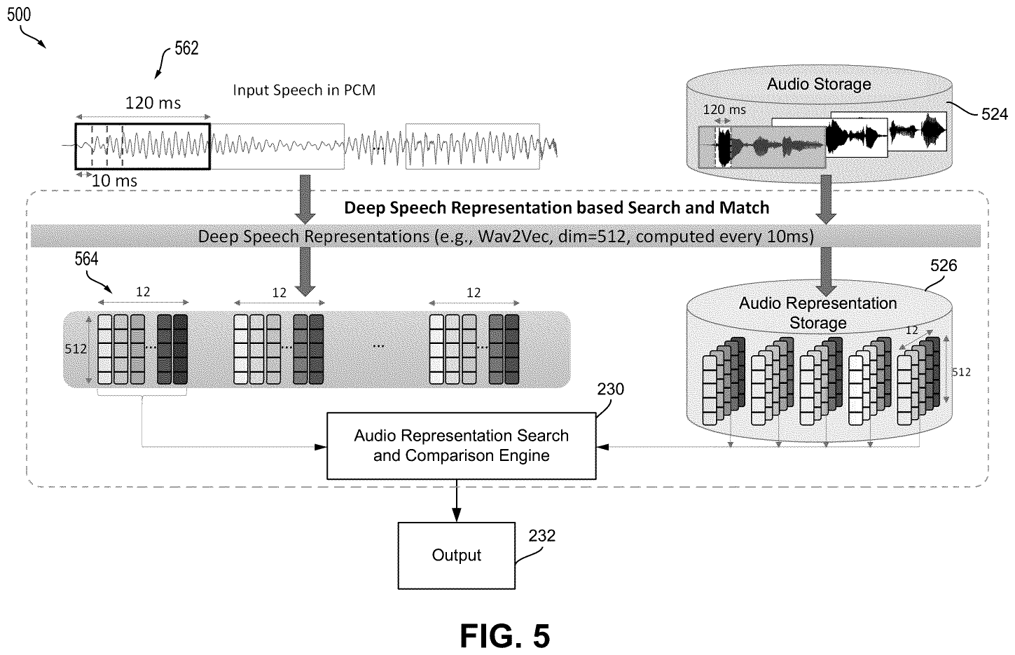

The audio in the audio storage 224 and the audio from the audio source can include speech (or voice), music, recorded sounds, any combination thereof, and/or other types of audio. Examples will be described herein using speech for illustrative purposes. However, one of ordinary skill will appreciate that the systems and techniques described herein apply to any type of audio information. For example, the audio data stored in the audio storage 224 can include Pulse-code modulation (PCM) speech samples. In some cases, the speech can be divided into segments (e.g., diphones including speech data from a middle of one phoneme of the speech to a middle of a next phoneme of the speech). In some aspects, the segments can have a fixed length, where all of the segments of the speech have a same (or common) length or duration. In some aspects, the segments can have a variable length, where the different segments can vary in length. In one illustrative example, the segments can vary in length from 30 milliseconds (ms) to 150 ms. In the event the audio is divided into variable-length segments, the audio processing system 220 can resample the segments to convert the segments having the variable length into audio segments having a fixed length (e.g., so that the speech segments have the same length or duration), as described below with respect to FIG. 5.

The representation generation engine 228 can include a machine learning system (or machine learning model) that can be used to generate representations of audio data from the audio stored in the audio storage 224 and representations of audio from the audio source 222. In some cases, the representation generation engine 228 can be implemented using and/or can operate in combination with an NPU (e.g., NPU 108 of FIG. 1), DSP (e.g., DSP 106), a CPU (e.g., CPU 102), and/or other processor(s) to apply the machine learning system to audio data. The machine learning system can be a neural network model that is trained to process audio data and generate one or more representations of the audio data. The representations can be feature vectors (also referred to as embedding vectors) that represent the audio data from which the representations are generated. Illustrative examples of neural networks that can be used as part of the representation generation engine 228 include convolutional neural networks (CNNs), recurrent neural networks (RNNs), generative adversarial networks (GANs), multilayer perceptron (MLP) neural networks, transformer neural networks, among others.

In examples where the machine learning system includes a neural network, the neural network can be trained using supervised learning, self-supervised learning, and/or other training technique. In some cases, a combination of supervised and self-supervised learning (and/other training techniques) may be used to train the machine learning system. In the event the neural network is trained using self-supervised learning, labelled ground truth data is not needed, in which case the neural network can be trained on a large amount of speech (e.g., 50,000 hours of speech) to provide a very accurate, universal model of the speech that can be stored in the audio representation storage 226. New use cases would require only updating the database with new audio data, which can be done on device (not offline), and there is no need to retrain the speech representation model stored in the audio representation storage 226.

As noted above, the representation generation engine 228 can use the machine learning model (e.g., the trained neural network) to process the audio (e.g., the segments of speech data) stored in the audio storage 224 to generate representations that represent characteristics of the stored audio data. In some cases, the representations can be feature vectors or embedding vectors generated by a neural network. As noted above, the representations of the stored speech can be stored in the audio representation storage 226 (e.g., an audio representation database).

The representation generation engine 228 can also use the machine learning model (e.g., the trained neural network) to process input audio from the audio source 222 to generate one or more representations (e.g., feature vectors or embedding vectors) that represent characteristics of the input audio data. In one illustrative example, the audio source 222 can include a microphone (or multiple microphones) and the input audio can include speech from a person captured by the microphone(s).

The audio representation search and comparison engine 230 can obtain (e.g., receive) the representation(s) of the input audio from the representation generation engine 228 and can obtain (e.g., retrieve) the stored representations from the audio storage 224. The audio representation search and comparison engine 230 can compare the representation(s) of the input audio to the stored representations to determine one or more stored representations that are closest to the representation(s) of the input audio. In some cases, the representation search and comparison engine 230 can use a distance calculation or metric (e.g., MSE, RMSE, SSE, or other distance metric) to compare the representation(s) of the stored speech to the representation(s) of the speech input to determine whether one or more representations of the stored speech matches the representation(s) of the speech input.

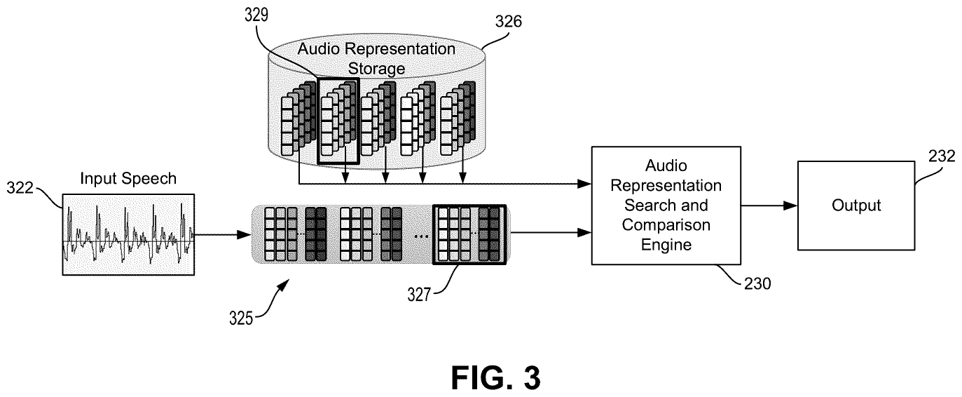

FIG. 3 is a diagram illustrating an example operation of the audio representation search and comparison engine 230 of the audio processing engine of FIG. 2. As noted above, the representations of the input audio and the stored audio can include feature vectors. For example, the feature vectors 325 are representations of the input speech 302 and the feature vectors in the audio representation storage 326 are representations of the audio data from the audio storage 224. Each of the feature vectors can include a certain number of values, such as 256 values, 512 values, or other number of values. The representation search and comparison engine 230 can use the distance calculation or metric (e.g., MSE, RMSE, SSE, or other distance metric) to determine a difference (or distance) between the values of one or more of the feature vectors 325 representing the input speech 302 and the values of one or more of the feature vectors in the audio representation storage 326. The one or more of the feature vectors in the audio representation storage 326 that result in the smallest (or minimum) distance value can be selected as matching feature vector(s).

In some cases, a certain number of representations can be generated for each segment of stored audio and for each segment of input audio, and the number of representations can be used by the audio representation search and comparison engine 230 to perform the comparison. For example, the audio processing system 220 can divide the into segments, with each segment having a length or duration of 120 ms. For a segment of audio having a length of 120 milliseconds, the audio processing system 220 can generate a feature every 10 ms, resulting in 12 feature vectors for the segment. As noted above, each feature vector can have a certain number of values (e.g., 256 values, 512 values, etc.). For example, referring to FIG. 3, a set of feature vectors 327 representing a segment of the input speech 322 can include 12 feature vectors and each feature vector can include 512 values. Similarly, a set of feature vectors 329 in the audio representation storage 326 representing a segment of the stored speech can include 12 feature vectors, with each feature vector can including 512 values. The audio representation search and comparison engine 230 can use the distance calculation (e.g., MSE, RMSE, SSE, or other distance metric) to determine differences between the values of the set of feature vectors 327 and values of various sets of feature vectors in the audio representation storage 326. Based on the distance calculation (which can be considered a matching cost), the audio representation search and comparison engine 230 can determine that the set of feature vectors 327 and the set of feature vectors 329 are a match based on the difference between the values of the set of feature vectors 327 and the values of the set of feature vectors 329 resulting in a minimum value from the determined differences.

As noted herein, the audio representation search and comparison engine 230 can select segments based on a best match (e.g., based on a matching cost) to the input, for each segment. However, it may be beneficial to select segments based on their temporal evolution (e.g., by selecting segments so as to minimize discontinuities between the segments). In some aspects, the audio representation search and comparison engine 230 can perform a beam search and concatenation operation (e.g., a Viterbi beam search and concatenation operation) to determine a match between one or more representations of the input speech and one or more of the representations stored in the audio representation storage 226. For example, the beam search and concatenation operation can be achieved by using a joint cost (e.g., indicating how much each output segment is different from, or “jumps”, from the previous output segment), in addition to the matching cost described above (how much each output segment varies from the matching input segment). The joint cost can be calculated using any suitable technique, such as using deep learned feature representations (e.g., the distance between a feature representation of the end of one segment and a feature representation of the beginning of the next segment), which can be generated using a neural network model or other machine learning model.

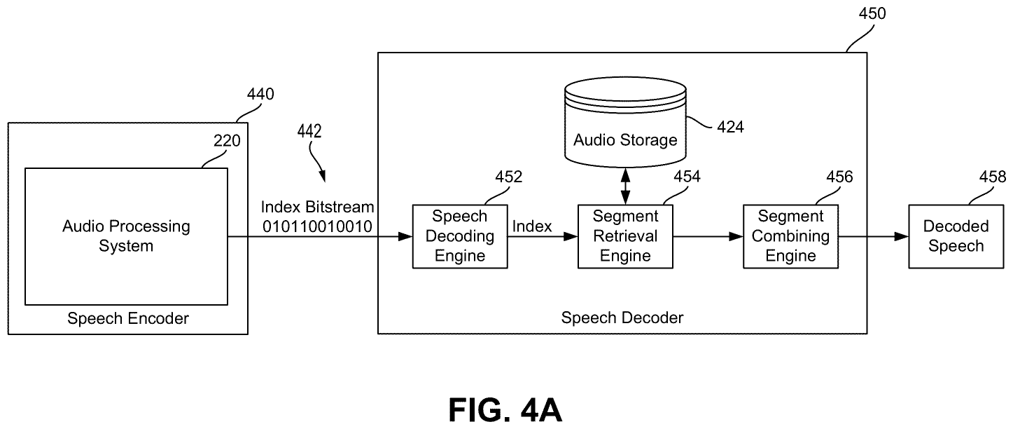

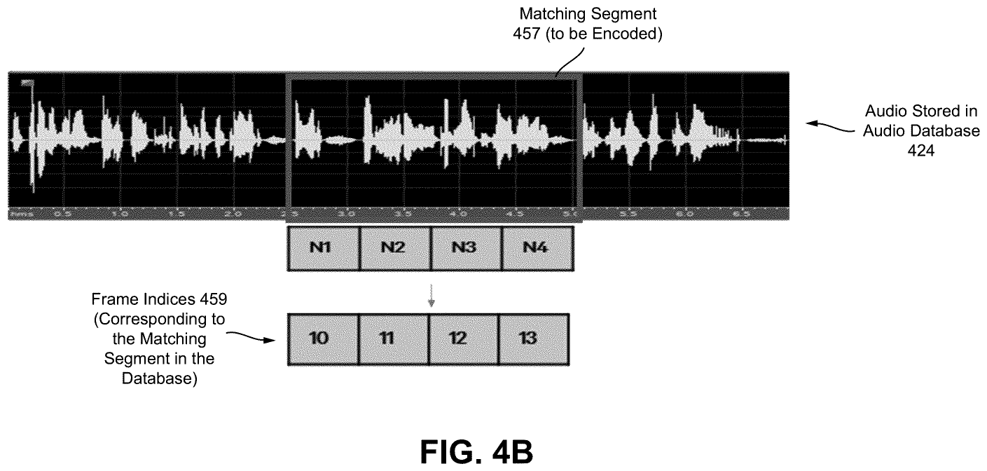

Based on determining a matching representation (or set of representations) from the audio representation storage 326, the audio processing system 220 can generate an output 232. The output 232 can include a best-matching audio segment (e.g., for voice conversion, audio event detection, or other application) from the audio storage 224, a matching accuracy or score (e.g., for voice activation, speech quality assessment, or other application), such as a value between 0 and 1, based on a match between one or more representations of the input audio and one or more representations of the stored audio stored in the audio representation storage 226, a bitstream (e.g., an index bitstream generated by a speech encoder as described with respect to FIG. 4A), and/or other type of output. For instance, a best-matching audio segment can be an audio segment that corresponds to a representation (or set of representations, such as the set of feature vectors 329) determined to match a representation (or set of representations, such as the set of feature vectors 327) of an input speech segment.

As noted above, in some cases, the audio processing system 220 can be part of a speech encoder, a speech decoder, or a combined speech encoder-decoder (referred to as a “codec”). FIG. 4A is a diagram illustrating an example of a speech encoder 440 and a speech decoder 450, according to aspects described herein. The speech encoder 440 includes the audio processing system 220 and can use the audio processing system 220 to generate an index bitstream 442. The index bitstream 442 represents indices identifying (or pointing to) locations within the audio storage 224 where speech segments are stored that correspond to speech representations (in audio representation storage 226) that are each determined to be a match with respective representations of input speech segments. The speech encoder can store the index bitstream or can transmit the index bitstream to a device including the speech decoder. The speech decoder 450 can receive the index bitstream 442 from the encoder.

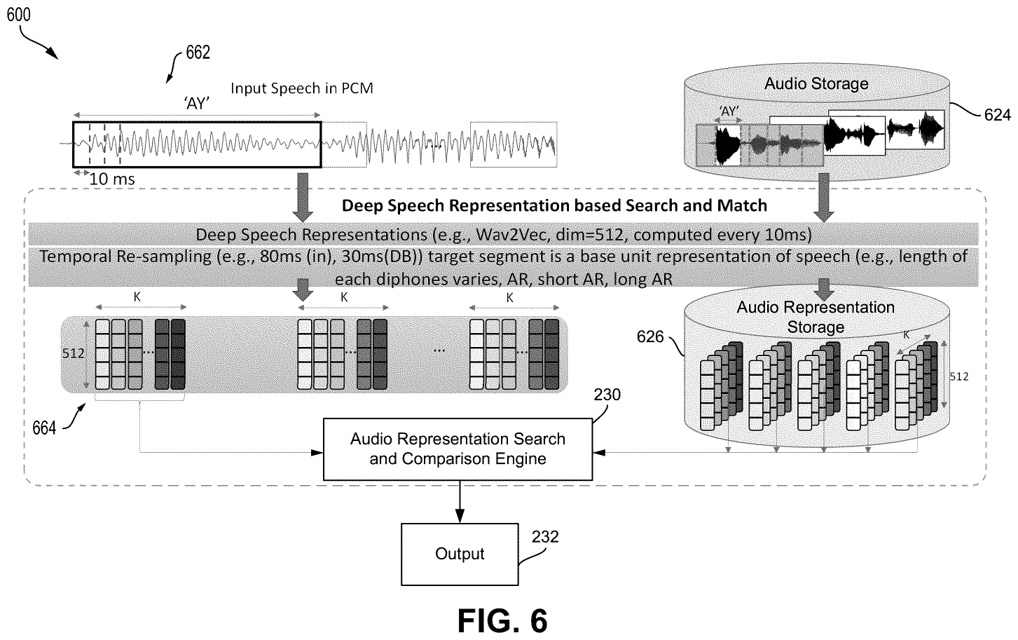

The audio processing system 220 of the speech encoder 440 includes the audio storage 224 and the audio representation storage 226, as described with respect to FIG. 2. The speech decoder 450 also includes an audio storage 424 that includes the same audio data as that stored in the audio storage 224 of the audio processing system 220. The audio storage 224 and the audio storage 424 can store speech from multiple people. The representations (e.g., feature vectors, such as the feature vectors of FIG. 3) stored in the audio representation storage 226 of the audio processing system 220 in the speech encoder 440 can be generated by the representation generation engine 228 to represent the speech (from the multiple people) stored in the audio storage 224. For example, the machine learning model (e.g., the neural network model) of the representation generation engine 228 in the audio processing system 220 can process the speech stored in the audio storage 224 to generate the representations representing the stored speech. For instance, the stored speech can be divided into segments. The segments can be fixed-length segments or can be variable-length segments, as described with respect to FIG. 5 and FIG. 6, respectively. The machine learning model can generate one or more respective representations for each segment. In one illustrative example, the audio data can be divided so that each segment has a duration or length of 120 ms, and the machine learning model of the representation generation engine 228 can generate a feature vector for every 10 seconds of each segment (e.g., 12 feature vectors having 512 values for a segment of 120 ms).

The speech encoder 440 can obtain (e.g., receive via one or more microphones, retrieve from storage, etc.) input speech of a person talking. The machine learning model of the representation generation engine 228 process the input speech to generate one or more representations e.g., feature vectors, such as the feature vectors of FIG. 3) for the input speech. For instance, similar to the speech stored in the audio storage 224, the encoder can divide the input speech into segments (e.g., fixed-length or variable-length segments) and can generate one or more respective representations for each segment of the input speech.

The audio representation search and comparison engine 230 of the speech encoder 440 can search the audio representation storage 226 for stored representation(s) that match the representation(s) generated for the input speech. For instance, the audio representation search and comparison engine 230 can perform a distance calculation or metric (e.g., MSE, RMSE, SSE, or other distance metric) to determine whether any of the representations stored in the audio representation storage 226 match the representation(s) generated for the speech input. In one example, as described with respect to FIG. 3, the representation search and comparison engine 230 can use the distance calculation (e.g., MSE, RMSE, SSE, or other distance metric) to determine a difference (or distance) between the values of one or more of the feature vectors 325 representing the input speech 302 and the values of one or more of the feature vectors in the audio representation storage 326. The one or more of the feature vectors in the audio representation storage 326 that result in the smallest (e.g., minimum) distance value can be selected as matching feature vector(s). In another example, as also described with respect to FIG. 3, the audio representation search and comparison engine 230 can use the distance calculation (e.g., MSE, RMSE, SSE, or other distance metric) to determine differences between values of various sets of features generated for the input speech 322 (e.g., the set of feature vectors 327) and values of various sets of feature vectors in the audio representation storage 326. Based on the distance calculation, the audio representation search and comparison engine 230 may determine that the set of feature vectors 327 representing the input speech 322 and the set of feature vectors 329 stored in the audio representation storage 326 are a match based on the difference between the values of the set of feature vectors 327 and the values of the set of feature vectors 329 resulting in a minimum value from the determined differences between the values of the set of feature vectors 327 and all (or a subset) of the stored feature vectors.

Based on the comparison, the speech encoder 440 can determine set of indices for the various speech segments that each correspond to a respective stored representation determined to match a respective segment of the speech input. Each index in the set of indices identifies a location in the audio storage of a particular speech segment that corresponds to one or more stored representations determined to match one or more segments of the speech input. In one illustrative example, referring to FIG. 3, an index in the set of indices can indicate a location in the audio storage 224 of a speech segment that corresponds to the stored set of feature vectors 329 (e.g., the speech segment from which the set of feature vectors 329 was generated using the representation generation engine 228) which were determined to match the set of feature vectors 327 representing a particular segment of the input speech 322.

After determined the set of indices for the speech input, the speech encoder 440 can encode the set of indices into the index bitstream 442. In one illustrative example, the speech encoder 440 can quantize and/or entropy code (e.g., using an arithmetic encoder) the index values of the set of indices to encode the set of indices into the index bitstream 442. The encoder 440 can store the bitstream and/or can transmit the bitstream to the speech decoder 450. The speech encoder 440 can encode the indices using any suitable technique, which in some cases can depend on the signal itself, transmission requirements, and/or other factors. In one illustrative example, the audio storage 224 may store N segments of fixed length L, in which case the speech encoder 440 may need to transmit B=log2(N) for each segment, every fixed length L. Additional coding techniques can also be performed. For instance, if one or more of the segments are expected to occur more often than others, the speech encoder 440 can perform run-length encoding, which can represent segments that occur more often with less bits and thus overall reduces bit rate. In another example, if a number of segments are expected to be consecutive (e.g., obtaining maximum length sequences from the database), then the speech encoder 440 may again use run length coding, in which case a single bit can be used to signal to the speech decoder 450 whether the consecutive segment in the database should be used, or that there should be a transition to another location in the database. In another example, such as if a fixed bit rate is desired, the speech encoder 440 can transmit the segment index every frame (e.g., every 20 ms), at the cost of higher bit rate (which will still be very low compared to traditional speech coders). Such an example can provide high error resilience if packets are lost in transmission, as most packets will be recovered as they are the previous index plus 1.

In another illustrative example of coding the indices, it can be assumed that with N bits, all the frame indices in the database can be coded. The value (2\hat{ }N)−1 be reserved as a special character (SC). In such an example, various techniques can be performed by the speech encoder 440 to encode the sequence of database indices. For instance, the speech encoder 440 can code the sequence of frame indices using N bits each, which can help with error resilience. FIG. 4B is a diagram illustrating such an example. As shown, N1, N2, N3, N4 of a matching audio segment 457 (for which an index is to be encoded) stored in the audio storage 424 are coded each with N bits, resulting in a total of 4*N bits. The resulting frame indices 459 are shown for each of N1, N2, N3, and N4, respectively. If the matching frame index is coded every 20 ms, then coding each index separately can be a high quality option. In the event the encoding can be delayed, a segment switch can be identified. In such cases, each matching segment can be coded efficiently using methods such as run-length coding, as described above. For example, each frame can be represented in the matching segment with the first frame index (N1) using N bits. The speech encoder 440 can then run length code the indices, and can insert the special character (SC) between the run length and the next index to identify the boundaries. In some cases, the speech encoder 440 can code each of N1, 4, and SC with N bits, for a total of 3*N bits.

The speech decoder 450 can decode the index bitstream 442 to determine the indices represented in the bitstream. In some cases, a speech decoding engine 452 of the speech decoder 450 can perform inverse quantization and/or entropy decoding (e.g., using an arithmetic decoder) to decode the index bitstream 442. For instance, the speech decoding engine 452 can perform the inverse of the encoding operation performed by the speech encoder 440, such as an inverse of the run length coding or other coding technique described above.

As noted above, the audio storage 424 of the speech decoder 450 stores the same audio data that is stored in the audio storage 224 of the audio processing system 220, in which case the set of indices can be used to identify the location in the audio storage 224 of the speech segments that were determined to match the input speech (based on the comparison of the representations of the input speech with the representations stored in the audio representation storage 326). Using the decoded set of indices, a segment retrieval engine 454 of the speech decoder 250 can retrieve the speech segments from the audio storage 424. The segment combining engine 456 of the speech decoder 250 can then combine the retrieved speech segments to generate decoded speech 458 (also referred to as reconstructed speech) that is similar to (e.g., sounds similar to) the input speech. In one example, the input speech can be a person saying, “Hello, my name is Bob.” By storing speech from a variety of users in the audio storage 224 and in the audio storage 424, the segment retrieval engine 454 is able to retrieve audio segments from the audio storage 424 that can be used to construct the same phrase as the input speech. The decoded speech 458 will thus be constructed using speech segments from different voices than the person that provided the speech input, but the voices will have similar speech characteristics as the person providing the input speech based on the comparison performed by the audio representation search and comparison engine 230. In some cases, to combine the retrieved speech segments, the segment combining engine 456 may concatenate each retrieved segment to a subsequent segment to generate a full speech output as the decoded speech 458. In some cases, the retrieved speech segments may overlap, in which case the segment combining engine 456 can align the segments so that the audio segments are properly aligned. For example, if the output is based on segments from different parts of the audio storage 224, the segments may not be fully aligned (and thus may be overlapping), in which case concatenating the audio segments (e.g., the PCM signals of the audio segments) may lead to a glitch or other error. In such cases, the segment combining engine 456 can align the segments (e.g., using a point of maximum correlation), and can use an overlap-and-add technique to ensure the transition between the segments is as smooth as possible.

By utilizing the audio processing system 220 to generate the index bitstream 442, the speech encoder 440 can greatly reduce the amount of data that needs to be provided to the speech decoder 450 for reconstructing the input speech. For instance, the speech encoder 440 does not need to transmit the actual speech (or a decoded version of the actual speech) to the speech decoder 450. In one illustrative example, the audio storage 224 and the audio storage 424 can each store two and a half hours of speech, and the stored speech can be divided into segments, such as diphone segments. For instance, two and a half hours of speech can correspond to approximately 96,000 different diphone segments. In some cases, as described herein, the diphone segments can vary in length from, for example, 30 ms to 150 ms, in which case, on average, the diphone segments are each approximately 100 milliseconds long. In other cases, the diphone segments are fixed length segments (e.g., 20 ms, 40 ms, 60 ms, etc.). The speech encoder 440 can use 17 bits to represent a number between one and 96,000 (corresponding to the 96,000 different diphone segments), based on the loge of 96,000. Thus, the speech encoder 440 can use 17 bits to represent one diphone segment. Using the variable-length example from above where the average length of a segment is 100 ms, there will be 10 segments per second and thus, on average, the speech encoder 440 can utilize only 170 bits per second (10 times 17 bits) for the index bitstream 442.

In some aspects, the audio processing system 220 can be part of a voice activation system. For instance, in such aspects, representations stored in the audio representation storage 226 can represent keywords. The keywords can be used as part of voice activation. For example, if one of the keywords is recognized in input speech from the audio source 222, the output 232 can be used to activate a device comprising a voice activation system to perform one or more functions (e.g., launch one or more applications, play music, set a timer, etc.). In one example, the representation generation engine 228 of the voice activation system can receive speech input from the audio source 222 and can use the machine learning system to generate one or more representations (e.g., a feature or embedding vector, such as the feature vectors 325 of FIG. 3) of the speech input. The audio representation search and comparison engine 230 can then determine if at least representation of the speech input matches one of the representations of the keywords stored in the audio representation storage 226. If a match is determined, the voice activation system can generate the output 232 to activate the corresponding function of a device including the audio processing system 220 or a separate device.

Another example of an application for which the audio processing system 220 can be used is speech quality assessment. For instance, the output 232 can indicate how well representations of speech input match stored representations of stored speech. In one example, the representation generation engine 228 of the voice activation system can receive speech input from the audio source 222 and can use the machine learning system to generate one or more representations (e.g., a feature or embedding vector, such as the feature vectors 325 of FIG. 3) of the speech input. The audio representation search and comparison engine 230 can then determine if at least representation of the speech input matches one of the representations of the keywords stored in the audio representation storage 226. If a match is determined, the voice activation system can generate the output 232, which can indicate how well the representations of the speech input matches the representations stored in the audio representation storage 226. In some cases, the output 232 can include a matching score, such as a value between 0 and 1, that indicates how well the representations of the speech input matches the representations stored in the audio representation storage 226. In some aspects, the matching score can be compared to a matching threshold (e.g., a value of 0.7, 0.8, 0.85, 0.9, or other value) to determine whether the input audio is of high quality. In one example, the output 232 can include a matching score of 0.8 and the matching threshold can be a value of 0.75, in which case the input audio can be determined to be of high quality (or sufficient quality for a given application). Such a solution can be used to determine the quality of a communication, such as a cellular phone conversation, a conference call using a conferencing tool, etc.

Other examples of applications for which the audio processing system 220 can be used include voice conversion (e.g., by outputting stored speech corresponding to a stored speech representation determined to match a speech representation generated for a speech input) and audio event detection (e.g., by identifying and outputting an indication of stored speech corresponding to a stored speech representation determined to match a speech representation generated for a speech input), among others.

FIG. 5 is a diagram 500 illustrating an example of audio framing using fixed-length segments. As shown in the illustrative example of FIG. 5, speech data stored in an audio storage 524 (e.g., stored as PCM samples) is divided into segments have a fixed length of 120 ms. Similarly, input speech is also divided into segments having a fixed length of 120 ms. The representation generation engine 228 can generate a certain number of representations (e.g., feature vectors) for each 120 ms segment. The representations can also be referred to as deep speech representations. As shown in FIG. 5, for an audio segment 562 of input speech, the representation generation engine 228 can generate a feature vector for every 10 second duration of the audio segment 562, resulting in 12 feature vectors. In the example of FIG. 5, each feature vector has 512 values. For example, the set of feature vectors 564 (including 12 feature vectors with each feature vector having 512 values) can be generated for the audio segment 562. The representations stored in the audio representation storage 526 can also include 12 feature vectors (with each feature vector having 512 values) for each speech segment having a length of 120 ms.

Using fixed-length speech segments can allow the audio representation search and comparison engine 230 to perform the difference or distance calculation (e.g., using MSE, etc.) using sets of representations having a common dimension (e.g., each set of feature vectors including an array or matrix of size 12×512) and determine the output 232.

FIG. 6 is a diagram 600 illustrating an example of audio framing using variable-length segments. For example, speech data stored in an audio storage 624 (e.g., stored as PCM samples) can be divided into segments having variable lengths between, for example, 30 ms to 150 ms. Similarly, input speech is also divided into segments having variable lengths (e.g., between 30 ms to 150 ms). As noted above, if the input speech is divided into segments of the same length as the stored speech segments, the resulting representations can be of a common dimension (e.g., each set of feature vectors representing a respective speech segment can be a matrix having a dimension of 12×512) and the distance or difference between the representations of the input speech and the representations of the stored speech can be easily determined. However, with the variable-length framing of FIG. 6, sets of representations of segments of varying lengths need to be compared (e.g., a set of representations of an input segment having a duration of 150 ms may need to be compared to a set of representations of a stored segment having a duration of 120 ms), which can be difficult due to the dimensions of the different sets of representations having different dimensions.

To solve such an issue, the audio processing system 220 can re-sample the one or more audio segments to convert the one or more audio segments of variable length into one or more audio segments of fixed length. The re-sampling can result in the representations of the input speech and the representations stored in the audio representation storage 626 having fixed framing (with fixed lengths), while the audio segments stored in the audio storage 624 have variable lengths. For instance, the representations of each speech segment can be resampled from the number of feature vectors generated for the speech segment (e.g., one feature vector for every 10 ms duration) to k number of feature vectors, resulting a set of re-sampled (e.g., downsampled) feature vectors having a dimension of k×N (where N is the number of values in each feature vector, such as a value of 512 as shown in FIG. 6). The value of k can be set to any suitable value (e.g., a value of 3, 5, 6, 7, etc.). In some cases, k can be a design parameter that can be adjusted in some cases to obtain a trade-off between quality and computation savings (e.g., a high value for k can lead to a high-quality match, which a low value for k can result in low computational cost).

In one illustrative example, k can be equal to 3. As described herein, the audio processing system 220 can calculate the representations (e.g., feature vectors) at a set period of time, such as every 10 ms. For instance, referring to FIG. 6, a speech segment 662 of input speech can have a length or duration of 150 ms, and the audio processing system 220 can calculate 15 representations (one representation every 10 ms of the speech segment 662). The audio processing system 220 can resample (e.g., downsample) the 15 representations by taking a subset of representations from the full set of representations (from the set of 15 representations), resulting in a re-sampled set of feature vectors 664 (having a dimension of k×512) for the speech segment 662. In one example, using k=3, the subset of representations selected by the audio processing system 220 can include the first representation, the last representation, and the representation in the middle. In another example, using k=5, for an input speech segment that includes the word “hello” and is 250 ms, the audio processing system 220 can generate 25 feature vectors (one feature vector every 10 ms). Using k=5 as an illustrative example, the audio processing system 220 system can downsample the set of 25 feature vectors by taking the first feature vector (e.g., vector 1), the feature vector (e.g., feature vector 25), a feature vector in the middle (e.g., vector 13), a feature vector at the quarter mark (e.g., feature vector 8), and a feature vector at the three-quarter mark (e.g., feature vector 18).

The audio processing system 220 can perform the same re-sampling for the speech segments stored in the audio storage 624, using a same k value that was used to re-sample the input speech. The re-sampled (e.g., downsampled) set of feature vectors having a dimension of k×N can then be used to perform the comparison by the audio representation search and comparison engine 230. For example, the re-sampled set of feature vectors 664 can be compared to the re-sampled sets of feature vectors stored in the audio representation storage 626 to determine a closest-matching re-sampled set of feature vectors and determine the output 232.

As described above, the audio processing system 220 can utilize one or more machine learning systems or models to generate the representations (e.g., feature or embedding vectors). Machine learning (ML) can be considered a subset of artificial intelligence (AI). ML systems can include algorithms and statistical models that computer systems can use to perform various tasks by relying on patterns and inference, without the use of explicit instructions. One example of a ML system is a neural network (also referred to as an artificial neural network), which may include an interconnected group of artificial neurons (e.g., neuron models). Neural networks may be used for various applications and/or devices, such as speech analysis, audio signal analysis, image and/or video coding, image analysis and/or computer vision applications, Internet Protocol (IP) cameras, Internet of Things (IoT) devices, autonomous vehicles, service robots, among others.

Individual nodes in a neural network may emulate biological neurons by taking input data and performing simple operations on the data. The results of the simple operations performed on the input data are selectively passed on to other neurons. Weight values are associated with each vector and node in the network, and these values constrain how input data is related to output data. For example, the input data of each node may be multiplied by a corresponding weight value, and the products may be summed. The sum of the products may be adjusted by an optional bias, and an activation function may be applied to the result, yielding the node's output signal or “output activation” (sometimes referred to as a feature map or an activation map). The weight values may initially be determined by an iterative flow of training data through the network (e.g., weight values are established during a training phase in which the network learns how to identify particular classes by their typical input data characteristics).

Different types of neural networks exist, such as convolutional neural networks (CNNs), recurrent neural networks (RNNs), generative adversarial networks (GANs), multilayer perceptron (MLP) neural networks, transformer neural networks, among others. For instance, convolutional neural networks (CNNs) are a type of feed-forward artificial neural network. Convolutional neural networks may include collections of artificial neurons that each have a receptive field (e.g., a spatially localized region of an input space) and that collectively tile an input space. RNNs work on the principle of saving the output of a layer and feeding this output back to the input to help in predicting an outcome of the layer. A GAN is a form of generative neural network that can learn patterns in input data so that the neural network model can generate new synthetic outputs that reasonably could have been from the original dataset. A GAN can include two neural networks that operate together, including a generative neural network that generates a synthesized output and a discriminative neural network that evaluates the output for authenticity. In MLP neural networks, data may be fed into an input layer, and one or more hidden layers provide levels of abstraction to the data. Predictions may then be made on an output layer based on the abstracted data.

Deep learning (DL) is one example of a machine learning technique and can be considered a subset of ML. Many DL approaches are based on a neural network, such as an RNN or a CNN, and utilize multiple layers. The use of multiple layers in deep neural networks can permit progressively higher-level features to be extracted from a given input of raw data. For example, the output of a first layer of artificial neurons becomes an input to a second layer of artificial neurons, the output of a second layer of artificial neurons becomes an input to a third layer of artificial neurons, and so on. Layers that are located between the input and output of the overall deep neural network are often referred to as hidden layers. The hidden layers learn (e.g., are trained) to transform an intermediate input from a preceding layer into a slightly more abstract and composite representation that can be provided to a subsequent layer, until a final or desired representation is obtained as the final output of the deep neural network.

As noted above, a neural network is an example of a machine learning system, and can include an input layer, one or more hidden layers, and an output layer. Data is provided from input nodes of the input layer, processing is performed by hidden nodes of the one or more hidden layers, and an output is produced through output nodes of the output layer. Deep learning networks typically include multiple hidden layers. Each layer of the neural network can include feature maps or activation maps that can include artificial neurons (or nodes). A feature map can include a filter, a kernel, or the like. The nodes can include one or more weights used to indicate an importance of the nodes of one or more of the layers. In some cases, a deep learning network can have a series of many hidden layers, with early layers being used to determine simple and low-level characteristics of an input, and later layers building up a hierarchy of more complex and abstract characteristics.

A deep learning architecture may learn a hierarchy of features. If presented with visual data, for example, the first layer may learn to recognize relatively simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases. Deep learning architectures may perform especially well when applied to problems that have a natural hierarchical structure. For example, the classification of motorized vehicles may benefit from first learning to recognize wheels, windshields, and other features. These features may be combined at higher layers in different ways to recognize cars, trucks, and airplanes.

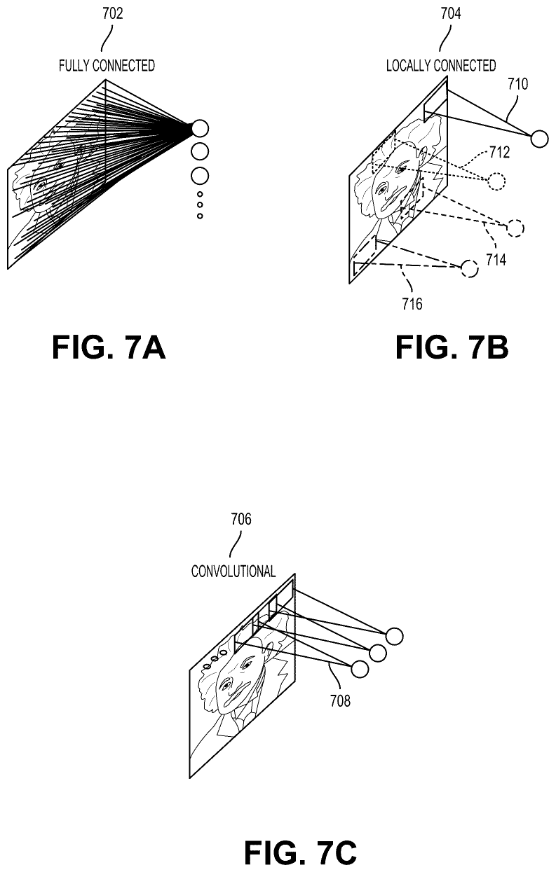

FIGS. 7A-7C illustrate example neural networks which may be used for keyword detection, in accordance with aspects of the present disclosure. Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

In some cases, the connections between layers of a neural network may be fully connected or locally connected. FIG. 7A illustrates an example of a fully connected neural network 702. In a fully connected neural network 702, a neuron in a first layer may communicate its output to every neuron in a second layer, so that each neuron in the second layer will receive input from every neuron in the first layer. FIG. 7B illustrates an example of a locally connected neural network 704. In a locally connected neural network 704, a neuron in a first layer may be connected to a limited number of neurons in the second layer. More generally, a locally connected layer of the locally connected neural network 704 may be configured so that each neuron in a layer will have the same or a similar connectivity pattern, but with connections strengths that may have different values (e.g., 710, 712, 714, and 716). The locally connected connectivity pattern may give rise to spatially distinct receptive fields in a higher layer, as the higher layer neurons in a given region may receive inputs that are tuned through training to the properties of a restricted portion of the total input to the network.

One example of a locally connected neural network is a convolutional neural network. FIG. 7C illustrates an example of a convolutional neural network 706. The convolutional neural network 706 may be configured such that the connection strengths associated with the inputs for each neuron in the second layer are shared (e.g., 708). Convolutional neural networks may be well suited to problems in which the spatial location of inputs is meaningful.

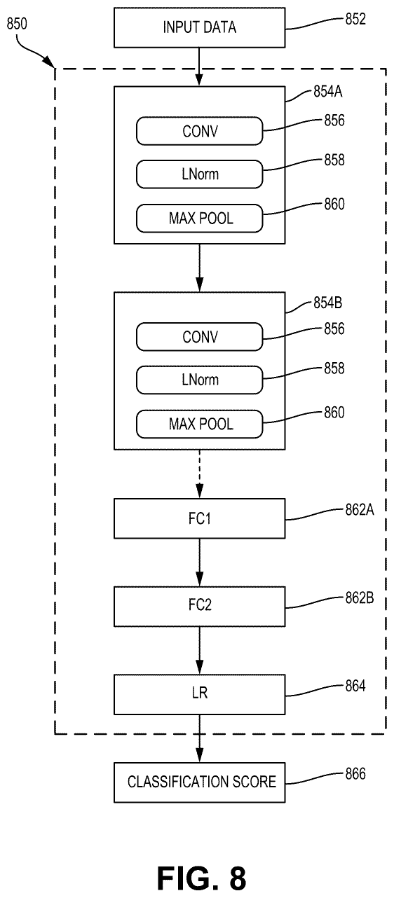

FIG. 8 is a block diagram illustrating an example of a deep convolutional network (DCN) 850, in accordance with aspects of the present disclosure. The DCN 850 may include multiple different types of layers based on connectivity and weight sharing. As shown in FIG. 8, the DCN 850 includes the convolution blocks 854A, 854B. Each of the convolution blocks 854A, 854B may be configured with a convolution layer (CONV) 856, a normalization layer (LNorm) 858, and a max pooling layer (MAX POOL) 860.

The convolution layers 856 may include one or more convolutional filters, which may be applied to the input data 852 to generate a feature map. Although only two convolution blocks 854A, 854B are shown, the present disclosure is not so limiting, and instead, any number of convolution blocks (e.g., blocks 854A, 854B) may be included in the DCN 850 according to design preference. The normalization layer 858 may normalize the output of the convolution filters. For example, the normalization layer 858 may provide whitening or lateral inhibition. The max pooling layer 860 may provide down sampling aggregation over space for local invariance and dimensionality reduction.

The parallel filter banks, for example, of a deep convolutional network may be loaded on a CPU 102 or GPU 104 of an SOC 100 to achieve high performance and low power consumption. In alternative embodiments, the parallel filter banks may be loaded on the DSP 106 or an ISP 116 of an SOC 100. In addition, the DCN 850 may access other processing blocks that may be present on the SOC 100, such as sensor processor 114 and keyword detection system 120, dedicated, respectively, to sensors and navigation.

The deep convolutional network 850 may also include one or more fully connected layers, such as layer 862A (labeled “FC1”) and layer 862B (labeled “FC2”). The DCN 850 may further include a logistic regression (LR) layer 864. Between each layer 856, 858, 860, 862A, 862B, 864 of the DCN 850 are weights (not shown) that are to be updated. The output of each of the layers (e.g., 856, 858, 860, 862A, 862B, 864) may serve as an input of a succeeding one of the layers (e.g., 886, 858, 860, 862A, 862B, 864) in the deep convolutional network 850 to learn hierarchical feature representations from input data 852 (e.g., images, audio, video, sensor data and/or other input data) supplied at the first of the convolution blocks 854A.

To adjust the weights, a learning algorithm may compute a gradient vector for the weights. The gradient may indicate an amount that an error would increase or decrease if the weight were adjusted. At the top layer, the gradient may correspond directly to the value of a weight connecting an activated neuron in the penultimate layer and a neuron in the output layer. In lower layers, the gradient may depend on the value of the weights and on the computed error gradients of the higher layers. The weights may then be adjusted to reduce the error. This manner of adjusting the weights may be referred to as “back propagation” as it involves a “backward pass” through the neural network.

In practice, the error gradient of weights may be calculated over a small number of examples, so that the calculated gradient approximates the true error gradient. This approximation method may be referred to as stochastic gradient descent. Stochastic gradient descent may be repeated until the achievable error rate of the entire system has stopped decreasing or until the error rate has reached a target level. After learning, the DCN may be presented with new input and a forward pass through the network may yield an output 422 that may be considered an inference or a prediction of the DCN.

The output of the DCN 850 is a classification score 866 for the input data 852. The classification score 866 may be a probability, or a set of probabilities, where the probability is the probability of the input data including a feature from a set of features the DCN 850 is trained to detect.

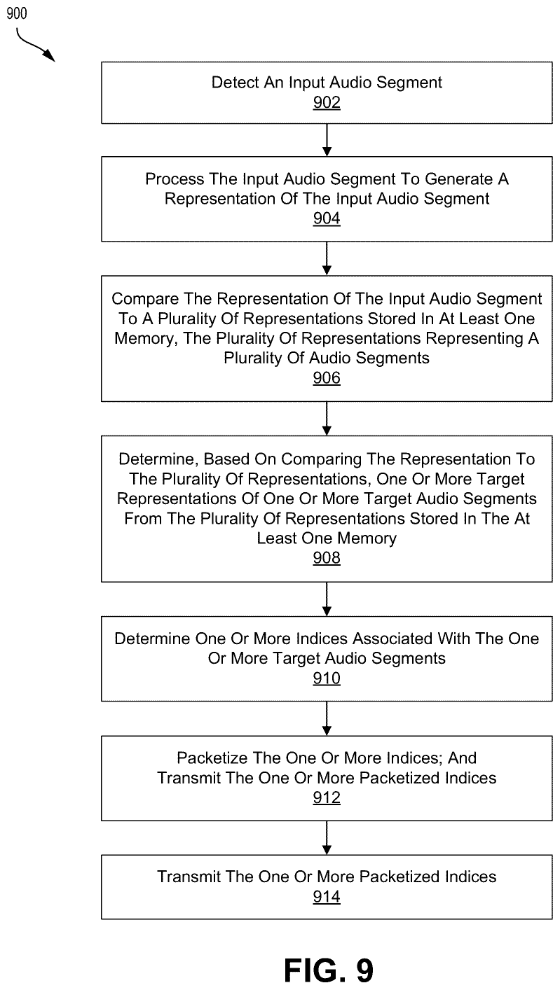

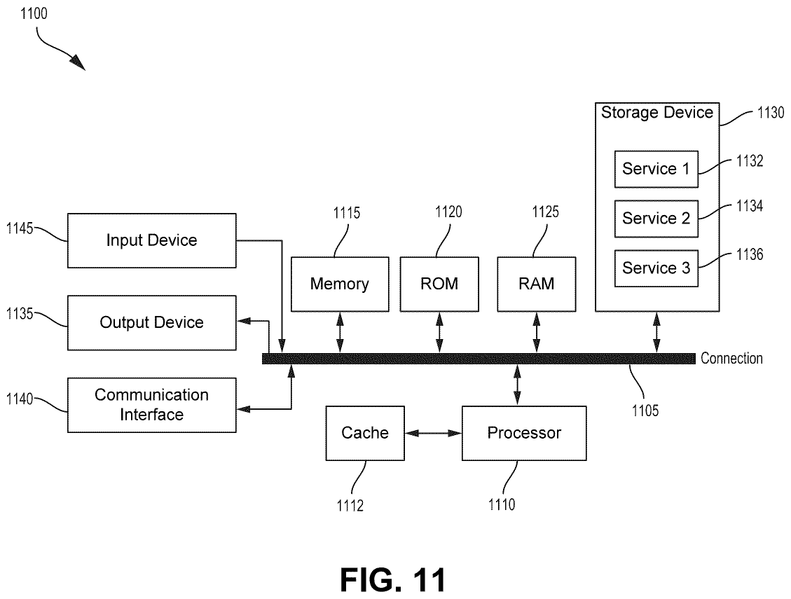

FIG. 9 is a flow diagram illustrating example a process 900 for encoding audio information, in accordance with aspects of the present disclosure. In some aspects, the process 900 can be performed by the speech encoder 440 of FIG. 4A and/or the audio processing system 220 of FIG. 2 and/or FIG. 4A. The operations of the process 900 may be implemented as software components that are executed and run on one or more processors (e.g., processor 1110 of FIG. 11 and/or other processor(s)). Further, the transmission and reception of signals by the wireless communications device in the process 900 may be enabled, for example, by one or more antennas and/or one or more transceivers (e.g., wireless transceiver(s)).

At operation 902, the speech encoder 440 can detect an input audio segment (e.g., an audio segment of audio obtained from the audio source 222). In some aspects, the input audio segment includes an input speech segment. At operation 904, the speech encoder 440 can process the input audio segment to generate a representation of the input audio segment. In some aspects, the representation of the input audio segment can include an embedding vector representing the input audio segment.

At operation 906, the speech encoder 440 can compare the representation of the input audio segment to a plurality of representations stored in at least one memory, the plurality of representations representing a plurality of audio segments. In some aspects, the plurality of audio segments include a plurality of speech segments. In such cases, the plurality of representations can include a plurality of embedding vectors representing the plurality of audio segments.

At operation 908, the speech encoder 440 can determine, based on comparing the representation to the plurality of representations, one or more target representations of one or more target audio segments from the plurality of representations stored in the at least one memory. In some aspects, to compare the representation of the input audio segment to the plurality of representations, the speech encoder 440 can determine a respective difference between the representation of the input audio segment and each respective representation of the plurality of representations. In some cases, the speech encoder 440 can further determine the one or more target representations based on one or more target representations having one or more smallest differences from the representation of the input audio segment out of the plurality of representations. In some aspects, the speech encoder 440 can determine the one or more target representations further based on a search and concatenation operation described herein.

In some aspects, the one or more target audio segments are of a fixed length. In some aspects, the one or more target audio segments are of variable length. In such aspects, the speech encoder 440 can resample the one or more target audio segments to convert the one or more target audio segments of variable length into one or more target audio segments of fixed length.

At operation 910, the speech encoder 440 can determine one or more indices associated with the one or more target audio segments. At operation 912, the speech encoder 440 can packetize the one or more indices. At operation 914, the speech encoder 440 can transmit the one or more packetized indices. In some aspects, the speech encoder 440 can encode the one or more packetized indices as an audio bitstream. In some cases, to transmit the one or more packetized indices, the speech encoder 440 can transmit the audio bitstream. In one illustrative example, the speech encoder 440 can transmit the audio bitstream at less than one thousand bits per second.

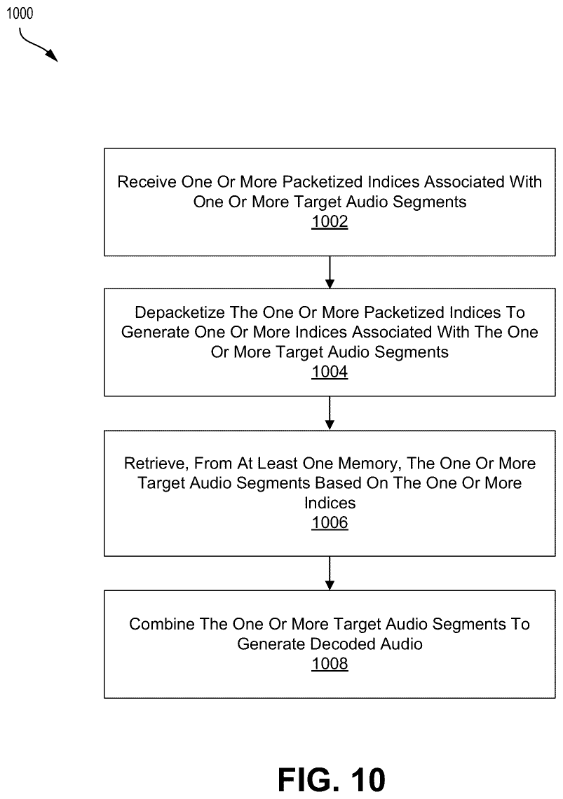

FIG. 10 is a flow diagram illustrating example a process 1000 for decoding audio information, in accordance with aspects of the present disclosure. In some aspects, the process 1000 can be performed by the speech decoder 450 of FIG. 4A. The operations of the process 1000 may be implemented as software components that are executed and run on one or more processors (e.g., processor 1110 of FIG. 11 and/or other processor(s)). Further, the transmission and reception of signals by the wireless communications device in the process 1000 may be enabled, for example, by one or more antennas and/or one or more transceivers (e.g., wireless transceiver(s)).

At operation 1002, the speech decoder 450 can receive one or more packetized indices associated with one or more target audio segments. In one illustrative example, the one or more target audio segments include one or more target speech segments. In some aspects, the speech decoder 450 can receive the one or more packetized indices as an audio bitstream. In some cases, the one or more target audio segments are of variable length. In one illustrative example, the audio bitstream is at less than one thousand bits per second. At operation 1004, the speech decoder 450 can depacketize the one or more packetized indices to generate one or more indices associated with the one or more target audio segments.

At operation 1006, the speech decoder 450 can retrieve, from at least one memory, the one or more target audio segments based on the one or more indices. At operation 1008, the speech decoder 450 can combine the one or more target audio segments to generate decoded audio. In some aspects, to combine the one or more target audio segments, the speech decoder 450 can concatenate the one or more target audio segments to generate the decoded audio. In some cases, the speech decoder 450 can output the decoded audio (e.g., via one or more speakers, store the decoded audio, transmit the decoded audio to another device, etc.).

In some aspects, the processes described herein (e.g., the process 900, the process 1000, and/or any other process described herein) may be performed by a computing device or apparatus. In one example, the process 900, the process 1000, and/or other technique or process described herein can be performed by the audio processing system 220 of FIG. 2. In another example, the process 900, the process 1000, and/or other technique or process described herein can be performed by the computing system 1100 shown in FIG. 11. For instance, a computing device with the computing device architecture of the computing system 1100 shown in FIG. 11 can implement the audio processing system 220 of FIG. 2 to perform operations of the process 900 and/or the operations of the process 1000.

The computing device can include any suitable device, such as a mobile device (e.g., a mobile phone), an extended reality (XR) device (e.g., a virtual reality (VR), augmented reality (AR), or mixed reality (MR) headset, AR or MR glasses, etc.), a wearable device (e.g., network-connected watch or other wearable device), a vehicle (e.g., an autonomous or semi-autonomous vehicle) or computing system or device of the vehicle, a desktop computing device, a tablet computing device, a server computer, a robotic device, a laptop computer, a network-connected television, a camera, and/or any other computing device with the resource capabilities to perform the processes described herein, including the process 700, the process 800, and/or any other process described herein. In some cases, the computing device or apparatus may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, a network interface configured to communicate and/or receive the data, any combination thereof, and/or other component(s). The network interface may be configured to communicate and/or receive Internet Protocol (IP) based data or other type of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

The process 900 and the process 1000 are illustrated as a logical flow diagram, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the process 900, the process 1000, and/or any other process described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 11 shows an example of computing system 1100, which can implement the various techniques described herein. For example, the computing system 1100 can implement the audio processing system 220 described with respect to FIG. 2, the process 900 of FIG. 9, the process 1000 of FIG. 10, and/or any other audio processing operation described herein. The components of the computing system 1100 are in communication with each other using connection 1105. Connection 1105 can be a physical connection via a bus, or a direct connection into processor 1110, such as in a chipset architecture. Connection 1105 can also be a virtual connection, networked connection, or logical connection.

In some embodiments, computing system 1100 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 1100 includes at least one processing unit (CPU or processor) 1110 and connection 1105 that couples various system components including system memory 1115, such as read-only memory (ROM) 1120 and random access memory (RAM) 1125 to processor 1110. Computing system 1100 can include a cache of high-speed memory 1112 connected directly with, in close proximity to, or integrated as part of processor 1110. In some cases, the computing system 1100 can copy data from memory 1115 and/or the storage device 1130 to the cache 1112 for quick access by processor 1110. In this way, the cache can provide a performance enhancement that avoids processor 1110 delays while waiting for data. These and other modules can control or be configured to control processor 1110 to perform various actions. Other computing device memory 1115 may be available for use as well. Memory 1115 can include multiple different types of memory with different performance characteristics.

Processor 1110 can include any general purpose processor and a hardware service or software service, such as a service 1 1132, a service 2 1134, and a service 3 1136 stored in storage device 1130, configured to control processor 1110 as well as a special-purpose processor where software instructions are incorporated into the actual processor design. Processor 1110 may essentially be a completely self-contained computing system, containing multiple cores or processors, a bus, memory controller, cache, etc. A multi-core processor may be symmetric or asymmetric.

To enable user interaction, computing system 1100 includes an input device 1145, which can represent any number of input mechanisms, such as a microphone for speech, a touch-sensitive screen for gesture or graphical input, keyboard, mouse, motion input, speech, etc. Computing system 1100 can also include output device 1135, which can be one or more of a number of output mechanisms known to those of skill in the art, such as a display, projector, television, speaker device, etc. In some instances, multimodal systems can enable a user to provide multiple types of input/output to communicate with computing system 1100. Computing system 1100 can include communication interface 1140, which can generally govern and manage the user input and system output. The communication interface may perform or facilitate receipt and/or transmission of wired or wireless communications via wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communication interface 1140 may also include one or more Global Navigation Satellite System (GNSS) receivers or transceivers that are used to determine a location of the computing system 1100 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1130 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc optical disc, a holographic optical disk, another optical medium, a secure digital (SD) card, a micro secure digital (microSD) card, a Memory Stick® card, a smartcard chip, a Europay Mastercard and Visa (EMV) chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L5/L #), resistive random-access memory (RRAM/ReRAM), phase change memory (PCM), spin transfer torque RAM (STT-RAM), another memory chip or cartridge, and/or a combination thereof.

The storage device 1130 can include software services (e.g., service 1 1132, service 2 1134, and service 3 1136, and/or other services), servers, services, etc., that when the code that defines such software is executed by the processor 1110, it causes the system to perform a function. In some embodiments, a hardware service that performs a particular function can include the software component stored in a computer-readable medium in connection with the necessary hardware components, such as processor 1110, connection 1105, output device 1135, etc., to carry out the function.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the embodiments and examples provided herein. However, it will be understood by one of ordinary skill in the art that the embodiments may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Individual embodiments may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific embodiments thereof, but those skilled in the art will recognize that the application is not limited thereto. Thus, while illustrative embodiments of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, embodiments can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” means A, B, or A and B. In another example, claim language reciting “at least one of A, B, and C” means A, B, C, or A and B, or A and C, or B and C, or A and B and C. The language “at least one of” a set and/or “one or more” of a set does not limit the set to the items listed in the set. For example, claim language reciting “at least one of A and B” can mean A, B, or A and B, and can additionally include items not listed in the set of A and B.

The various illustrative logical blocks, modules, circuits, and algorithm steps described in connection with the examples disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative Aspects of the Disclosure Include:

Aspect 1. An apparatus for encoding audio information, the apparatus comprising: at least one memory; and at least one processor coupled to the at least one memory and configured to: detect an input audio segment; process the input audio segment to generate a representation of the input audio segment; compare the representation of the input audio segment to a plurality of representations stored in the at least one memory, the plurality of representations representing a plurality of audio segments; determine, based on comparing the representation to the plurality of representations, one or more target representations of one or more target audio segments from the plurality of representations stored in the at least one memory; determine one or more indices associated with the one or more target audio segments; packetize the one or more indices; and transmit the one or more packetized indices.

Aspect 2. The apparatus of Aspect 1, wherein the representation of the input audio segment includes an embedding vector representing the input audio segment, and wherein the plurality of representations includes a plurality of embedding vectors representing the plurality of audio segments.

Aspect 3. The apparatus of any of Aspects 1 or 2, wherein the one or more target audio segments are of variable length.

Aspect 4. The apparatus of Aspect 3, wherein the at least one processor is configured to resample the one or more target audio segments to convert the one or more target audio segments of variable length into one or more target audio segments of fixed length.

Aspect 5. The apparatus of any of Aspects 1 to 4, wherein: the at least one processor is configured to encode the one or more packetized indices as an audio bitstream; and to transmit the one or more packetized indices, the at least one processor is configured to transmit the audio bitstream.

Aspect 6. The apparatus of Aspect 5, wherein the at least one processor is configured to transmit the audio bitstream at less than one thousand bits per second.

Aspect 7. The apparatus of any of Aspects 1 to 6, wherein: to compare the representation of the input audio segment to the plurality of representations, the at least one processor is configured to determine a respective difference between the representation of the input audio segment and each respective representation of the plurality of representations; and the at least one processor is configured to determine the one or more target representations based on one or more target representations having one or more smallest differences from the representation of the input audio segment out of the plurality of representations.

Aspect 8. The apparatus of Aspect 7, wherein the at least one processor is configured to determine the one or more target representations further based on a search and concatenation operation.

Aspect 9. The apparatus of any of Aspects 1 to 8, wherein the input audio segment includes an input speech segment, and wherein the plurality of audio segments include a plurality of speech segments.

Aspect 10. An apparatus for decoding audio information, the apparatus comprising: at least one memory; and at least one processor coupled to the at least one memory and configured to: receive one or more packetized indices associated with one or more target audio segments; depacketize the one or more packetized indices to generate one or more indices associated with the one or more target audio segments; retrieve, from the at least one memory, the one or more target audio segments based on the one or more indices; and combine the one or more target audio segments to generate decoded audio.

Aspect 11. The apparatus of Aspect 10, wherein, to combine the one or more target audio segments, the at least one processor is configured to concatenate the one or more target audio segments to generate the decoded audio.

Aspect 12. The apparatus of any of Aspects 10 or 11, wherein the at least one processor is configured to output the decoded audio.

Aspect 13. The apparatus of any of Aspects 10 to 12, wherein the one or more target audio segments are of variable length.

Aspect 14. The apparatus of any of Aspects 10 to 13, wherein the at least one processor is configured to receive the one or more packetized indices as an audio bitstream.

Aspect 15. The apparatus of Aspect 14, wherein the audio bitstream is at less than one thousand bits per second.

Aspect 16. The apparatus of any of Aspects 10 to 15, wherein the one or more target audio segments include one or more target speech segments.

Aspect 17. A method for encoding audio information, comprising: detecting an input audio segment; processing the input audio segment to generate a representation of the input audio segment; comparing the representation of the input audio segment to a plurality of representations stored in at least one memory, the plurality of representations representing a plurality of audio segments; determining, based on comparing the representation to the plurality of representations, one or more target representations of one or more target audio segments from the plurality of representations stored in the at least one memory; determining one or more indices associated with the one or more target audio segments; packetizing the one or more indices; and transmitting the one or more packetized indices.

Aspect 18. The method of Aspect 17, wherein the representation of the input audio segment includes an embedding vector representing the input audio segment, and wherein the plurality of representations includes a plurality of embedding vectors representing the plurality of audio segments.

Aspect 19. The method of any of Aspects 17 or 18, wherein the one or more target audio segments are of variable length.

Aspect 20. The method of Aspect 19, further comprising resampling the one or more target audio segments to convert the one or more target audio segments of variable length into one or more target audio segments of fixed length.

Aspect 21. The method of any of Aspects 17 to 20, further comprising: encoding the one or more packetized indices as an audio bitstream; wherein transmitting the one or more packetized indices comprises transmitting the audio bitstream.

Aspect 22. The method of Aspect 21, further comprising transmitting the audio bitstream at less than one thousand bits per second.

Aspect 23. The method of any of Aspects 17 to 22, wherein comparing the representation of the input audio segment to the plurality of representations comprises determining a respective difference between the representation of the input audio segment and each respective representation of the plurality of representations, and further comprising: determining the one or more target representations based on one or more target representations having one or more smallest differences from the representation of the input audio segment out of the plurality of representations.

Aspect 24. The method of Aspect 23, further comprising determining the one or more target representations further based on a search and concatenation operation.

Aspect 25. The method of any of Aspects 17 to 24, wherein the input audio segment includes an input speech segment, and wherein the plurality of audio segments include a plurality of speech segments.

Aspect 26. A method of decoding audio information, comprising: receiving one or more packetized indices associated with one or more target audio segments; depacketizing the one or more packetized indices to generate one or more indices associated with the one or more target audio segments; retrieving, from at least one memory, the one or more target audio segments based on the one or more indices; and combining the one or more target audio segments to generate decoded audio.

Aspect 27. The method of Aspect 26, wherein combining the one or more target audio segments comprises concatenating the one or more target audio segments to generate the decoded audio.

Aspect 28. The method of any of Aspects 26 or 27, further comprising outputting the decoded audio.

Aspect 29. The method of any of Aspects 26 to 28, wherein the one or more target audio segments are of variable length.

Aspect 30. The method of any of Aspects 26 to 29, further comprising receiving the one or more packetized indices as an audio bitstream.

Aspect 31. The method of claim 30, wherein the audio bitstream is at less than one thousand bits per second.

Aspect 32. The method of any of Aspects 26 to 31, wherein the one or more target audio segments include one or more target speech segments.

Aspect 33. The non-transitory computer-readable medium of any of Aspects 17 to 25.

Aspect 34. An apparatus for encoding audio information, the apparatus comprising one or more means for performing operations according to any of Aspects 17 to 25.

Aspect 35. The non-transitory computer-readable medium of any of Aspects 26 to 32.

Aspect 36. An apparatus for decoding audio information, the apparatus comprising one or more means for performing operations according to any of Aspects 26 to 32.

Aspect 37. The non-transitory computer-readable medium of any of Aspects 17 to 25 and Aspects 26 to 32.

Aspect 38. An apparatus for processing audio information, the apparatus comprising one or more means for performing operations according to any of Aspects 17 to 25 and Aspects 26 to 32.

What is claimed is:

1. An apparatus for encoding audio information, the apparatus comprising:
at least one memory; and
at least one processor coupled to the at least one memory and configured to:
detect an input audio segment;
process the input audio segment to generate a representation of the input audio segment;
compare the representation of the input audio segment to a plurality of representations stored in the at least one memory, the plurality of representations representing a plurality of audio segments;
determine, based on comparing the representation to the plurality of representations, one or more target representations of one or more target audio segments from the plurality of representations stored in the at least one memory;
determine one or more indices associated with the one or more target audio segments;
packetize the one or more indices; and
transmit the one or more packetized indices.

2. The apparatus of claim 1, wherein the representation of the input audio segment includes an embedding vector representing the input audio segment, and wherein the plurality of representations includes a plurality of embedding vectors representing the plurality of audio segments.

3. The apparatus of claim 1, wherein the one or more target audio segments are of variable length.

4. The apparatus of claim 3, wherein the at least one processor is configured to resample the one or more target audio segments to convert the one or more target audio segments of variable length into one or more target audio segments of fixed length.

5. The apparatus of claim 1, wherein:
the at least one processor is configured to encode the one or more packetized indices as an audio bitstream; and
to transmit the one or more packetized indices, the at least one processor is configured to transmit the audio bitstream.

6. The apparatus of claim 5, wherein the at least one processor is configured to transmit the audio bitstream at less than one thousand bits per second.

7. The apparatus of claim 1, wherein:
to compare the representation of the input audio segment to the plurality of representations, the at least one processor is configured to determine a respective difference between the representation of the input audio segment and each respective representation of the plurality of representations; and
the at least one processor is configured to determine the one or more target representations based on one or more target representations having one or more smallest differences from the representation of the input audio segment out of the plurality of representations.

8. The apparatus of claim 7, wherein the at least one processor is configured to determine the one or more target representations further based on a search and concatenation operation.

9. The apparatus of claim 1, wherein the input audio segment includes an input speech segment, and wherein the plurality of audio segments include a plurality of speech segments.

10. An apparatus for decoding audio information, the apparatus comprising:
at least one memory; and
at least one processor coupled to the at least one memory and configured to:
receive one or more packetized indices associated with one or more target audio segments;
depacketize the one or more packetized indices to generate one or more indices associated with the one or more target audio segments;
retrieve, from the at least one memory, the one or more target audio segments based on the one or more indices; and
combine the one or more target audio segments to generate decoded audio.

11. The apparatus of claim 10, wherein, to combine the one or more target audio segments, the at least one processor is configured to concatenate the one or more target audio segments to generate the decoded audio.

12. The apparatus of claim 10, wherein the at least one processor is configured to output the decoded audio.

13. The apparatus of claim 10, wherein the one or more target audio segments are of variable length.

14. The apparatus of claim 10, wherein the at least one processor is configured to receive the one or more packetized indices as an audio bitstream.

15. The apparatus of claim 14, wherein the audio bitstream is at less than one thousand bits per second.

16. The apparatus of claim 10, wherein the one or more target audio segments include one or more target speech segments.

17. A method for encoding audio information, comprising:
detecting an input audio segment;
processing the input audio segment to generate a representation of the input audio segment;
comparing the representation of the input audio segment to a plurality of representations stored in at least one memory, the plurality of representations representing a plurality of audio segments;
determining, based on comparing the representation to the plurality of representations, one or more target representations of one or more target audio segments from the plurality of representations stored in the at least one memory;
determining one or more indices associated with the one or more target audio segments;
packetizing the one or more indices; and
transmitting the one or more packetized indices.

18. The method of claim 17, wherein the representation of the input audio segment includes an embedding vector representing the input audio segment, and wherein the plurality of representations includes a plurality of embedding vectors representing the plurality of audio segments.

19. The method of claim 17, wherein the one or more target audio segments are of variable length.

20. The method of claim 19, further comprising resampling the one or more target audio segments to convert the one or more target audio segments of variable length into one or more target audio segments of fixed length.

21. The method of claim 17, further comprising:
encoding the one or more packetized indices as an audio bitstream;
wherein transmitting the one or more packetized indices comprises transmitting the audio bitstream.

22. The method of claim 17, wherein comparing the representation of the input audio segment to the plurality of representations comprises determining a respective difference between the representation of the input audio segment and each respective representation of the plurality of representations, and further comprising:
determining the one or more target representations based on one or more target representations having one or more smallest differences from the representation of the input audio segment out of the plurality of representations.

23. The method of claim 22, further comprising determining the one or more target representations further based on a search and concatenation operation.

24. The method of claim 17, wherein the input audio segment includes an input speech segment, and wherein the plurality of audio segments include a plurality of speech segments.

25. A method of decoding audio information, comprising:
receiving one or more packetized indices associated with one or more target audio segments;
depacketizing the one or more packetized indices to generate one or more indices associated with the one or more target audio segments;
retrieving, from at least one memory, the one or more target audio segments based on the one or more indices; and
combining the one or more target audio segments to generate decoded audio.

26. The method of claim 25, wherein combining the one or more target audio segments comprises concatenating the one or more target audio segments to generate the decoded audio.

27. The method of claim 25, further comprising outputting the decoded audio.

28. The method of claim 25, wherein the one or more target audio segments are of variable length.

29. The method of claim 25, further comprising receiving the one or more packetized indices as an audio bitstream.

30. The method of claim 25, wherein the one or more target audio segments include one or more target speech segments.
